(19) United States
(12) Patent Application Publication
(10) Pub. No.: US 2012/0226638 A1
(43) Pub. Date: Sep. 6, 2012

(54) SYSTEM AND METHOD FOR PAIRING SECURITY DEVICES WITH RETAIL PRODUCTS

(75) Inventors: Adam Mark Will, Fort Mill, SC (US); William R. Beatty, Davidson, NC (US); Matthew R. Shute, Huntersville, NC (US); Deidra Leigh Grier, Indian Trail, NC (US); Donna Marie Licari Gudridge, Mooresville, NC (US)

(73) Assignee: CHECKPOINT SYSTEMS, INC., Philadelphia, PA (US)

(21) Appl. No.: 13/422,616

(22) Filed: Mar. 16, 2012

Related U.S. Application Data
(63) Continuation-in-part of application No. 13/248,720, filed on Sep. 29, 2011.
(60) Provisional application No. 61/391,270, filed on Oct. 8, 2010.

(51) Int. Cl. G06Q 90/00; G09F 3/10; G09F 3/00

(52) U.S. Cl. 705/500; 40/299.01; 40/638

(57) ABSTRACT

The invention relates to a security container formed to receive a cassette which visually indicates to a user what type or style of good is contained therein. The cassette may be of a general solid block type in one color or having one visual characteristic, or the cassette may have multiple inserts or slides which may be moved within the cassette to change the outwardly facing color or visible characteristic. The invention furthermore relates to a merchandising system and method for paring the appropriate security device with the correct high-theft piece of merchandise and for return of a previously used security device to the correct department of a retail establishment. In some configurations, a scan device can be used to scan a product and then display a color label associated with a security device to be used with that product.

### CROSS-REFERENCE TO RELATED APPLICATIONS

This application is a continuation-in-part of U.S. patent application Ser. No. 13/248,720, filed Sep. 29, 2011, which claimed priority from U.S. Provisional Patent Application Ser. No. 61/391,270, filed Oct. 8, 2010, the disclosures of which are incorporated herein by reference.

### BACKGROUND OF THE INVENTION

1. Technical Field

This invention relates to a container for displaying and securing commercial goods. More particularly, this invention relates to selectively configuring the container to provide a visual indication of what type or style of commercial goods is contained therein. Specifically, this invention relates to a color-coded cassette insert for a clam-shell security container, which is used to visually indicate compatibility information about the goods contained therein. The invention further relates to a system and method to provide retailers with an inexpensive means for protecting high-theft merchandise by pairing various security products with the particular retail products to be protected thereby.

2. Background Information

Commercial stores often display goods which are only compatible with one type of an electronic gaming or computer system. For example, a Nintendo® Wii® gaming console will only play Wii® games, and likewise for a Microsoft® Xbox® console and games. A Wii® game will not play on an Xbox® console. However, multiple versions of the same goods may be offered. For example, the same game may be offered in the Wii® format as well as the Xbox® format. These games are often sold side-by-side on the store shelf in similar packaging. It is up to the purchaser or store employee to identify whether the particular good is compatible with the particular system. Often the store employee isn't properly trained, or a customer is in a hurry. As such, the store employee or customer may retrieve the wrong item due to ignorance or oversight.

Heretofore, security containers which hold these goods have provided no indication of the style or compatibility of the goods contained therein. These security containers are generally of the “clam-shell” style, which accept and hold the goods between two portions which are locked together. The goods are generally displayed through a transparent portion, and the only indication of the compatibility is on the packaging for the goods. Oftentimes the print is small, or different manufacturers provide the compatibility information in different places on the goods, so the employee is left to search all over the goods, front and back, to determine the compatibility.

Further, during a particularly busy part of the day or during a holiday rush, retailers are typically understaffed or retail associates from other departments are rotated to the busier departments to assist customers. Thus, a retail associate may not be aware of the slight differences in the items, or may not be able to discern these differences quickly. Retail establishments are constantly trying to make shopping more efficient for busy customers, while maintaining a pleasant customer experience. Requiring a customer to wait for the retail associate to study the item, or requiring the customer to return an item to receive the appropriate style is wholly inefficient and typically leads to customer agitation and a poor shopping experience.

Another problem that exists in many large retail establishments having different departments is that each department is responsible for its own budget including obtaining the needed security products to protect high theft merchandise. Thus, the health and beauty aids department will require a certain number and variety of security products; the sporting goods department will require a certain number and type of security products; and the electronics department will require its own number and type of various security products, etc. Many of these security products will be the same used by each or several of the various departments. For example, the same security box having a locking mechanism and security tag incorporated therein will be used to protect expensive bottles of perfume in one department, electronic games in another department, etc. However, at the time of checkout, the security protected products will be removed from the security device at the checkout counter. Later, it is difficult to determine which security device should be returned to which department in the retail establishment. This results in the incorrect return of the security devices among the various departments. Also, as discussed previously, it is sometimes difficult to ensure that the correct retail product is secured by the correct security device due to the vast number of employees, some full and some part time, as well as the need for speed in certain retail environments, and the slight differences in the various products and vast array of security devices to be used therewith.

Therefore, a need exists in the art to provide a security container which readily visually indicates compatibility information about the goods contained therein to the viewer. Furthermore, there is a need for a system and method for matching the correct security device with the appropriate high-theft merchandise to be protected therein; and to which store location or department the security device belongs and is intended for use.

### BRIEF SUMMARY OF THE INVENTION

The first embodiment of the present invention relates to a combination of a security container and at least one cassette. The security container includes a top end, a bottom end, a first side, and a second side, wherein the first side and second side are hingedly locked at the bottom end, and releaseably lockable at the top end. The security container further includes a cassette receiving portion defined by the first side and proximate the top end when the first side and second side are locked together. The cassette is sized to be selectively inserted and removed from the cassette receiving portion of the security container. The cassette is generally one solid color, which is outwardly displayed at the top end of the security container when the first and second sides are locked together. The color indicates that the goods contained in that particular security container conform to a particular compatibility with electronic equipment. For example, Nintendo® Wii® games may be indicated by a white cassette, and Microsoft® Xbox® games may be indicated by a black cassette.

The second embodiment of the invention relates to a multi-color cassette for use with the security container described above. The cassette includes a cassette base having a base wall, a pair of sidewalls extending from the base wall, a backwall extending between the pair of sidewalls, an inner surface, and an outer surface. The cassette further includes a plurality of inserts, each insert having a particular color and a protrusion, and a plurality of grooves defined by the inner surface. Each insert is sized to be disposed in the cassette base with the projection of the insert received by one of the plurality of recesses. The cassette base includes an indicator opening or window defined by the base wall and the pair of sidewalls, wherein one of the inserts is visible in the indicator opening when the inserts are disposed in the cassette base. As such, each insert may be moved to the position where the color of the insert is visible through the indicator opening, thereby changing the overall outwardly facing color portrayed by the cassette. The non-visible inserts are disposed in the cassette for future selective use.

Another objective achieved by the present invention is to provide a method and a matching system to better protect high-theft merchandise and provide the retailer with increased on-shelf availability, reduction in the amount of time for shelf stocking, and acceleration of organization in the back storage room and sales floor of the retail establishment.

Furthermore, the invention ensures that the correct security device is utilized for protecting the correct piece of merchandise and that each department within a retail establishment maintains control over its own security devices by providing a coded indicia, preferably a color-coding indicia, on each of the security devices which is matched against an appropriate color-coded indicia associated with each of the products to be protected thereby. This enables the correct security device to be easily matched and associated with the desired retail product after being returned to its correct department from a checkout station.

A further feature of the present invention is to provide a kit for merchandising and protecting from theft certain retail products which is relatively inexpensive for a merchant consisting of various printed labels having a color code thereon adapted to be secured to the various security products, store shelves, and storage bins, all of which are coordinated by a poster having a plurality of color box pictorials thereon. This kit is easily utilized in a retail establishment at a minimal cost without affecting the visual display of the product and greatly facilitates the work of the various store clerks.

### BRIEF DESCRIPTION OF THE SEVERAL VIEWS OF THE DRAWINGS

A preferred embodiment of the invention, illustrated of the best mode in which Applicant contemplates applying the principles, is set forth in the following description and is shown in the drawings and is particularly and distinctly pointed out and set forth in the appended claims.

FIG. 1 is a perspective view of a security container having a first embodiment of a cassette of the present invention inserted therein;

FIG. 2 is an exploded view of the security container and the first embodiment of the cassette;

FIG. 3 is a front side perspective view of a second embodiment of the cassette of the present invention;

FIG. 4 is a front side perspective view of the second embodiment of the cassette having a slide removed therefrom;

FIG. 5 is rear side perspective view of the second embodiment of the cassette;

FIG. 6 is a cross-sectional view taken along line 6-6 of FIG. 5;

FIG. 7 is a top plane view of the second embodiment of the cassette;

FIG. 8 is an enlarged view of a portion of FIG. 7;

FIG. 9 is a diagrammatic view showing the various components of the merchandising system and kit of the present invention;

FIG. 10 is an enlarged view of one of the color boxes from one of the wall posters;

FIG. 11 is a diagrammatic view of the various security device labels with one of the labels placed on the bottom of one of the security devices;

FIG. 12 is a diagrammatic view showing a plurality of bin labels and a stack of bins having the appropriate label placed thereon;

FIG. 13 is a diagrammatic view showing a plurality of the shelf labels, one of which is placed on a shelf containing the product and its associated security device with the identifying shelf label; and

FIG. 14 is a perspective example view of a scanning device that can be used to scan a product and then display a colored label indicating what security device is associated with that product.

Similar numbers refer to similar parts throughout the drawings.

### DETAILED DESCRIPTION OF THE INVENTION

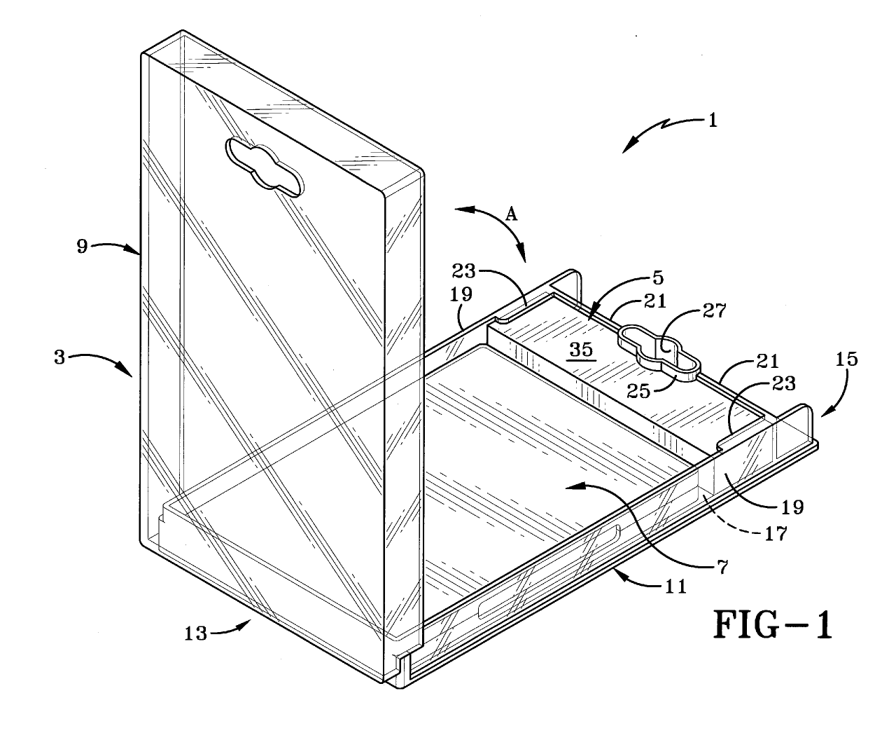

The security device of the present invention is shown in FIGS. 1-8 and indicated generally at 1. As shown in FIG. 1, security device 1 includes a security container 3 and a cassette 5 selectively securable thereto. Security container 3 is generally comprised of a first portion 9 and a second portion 11, whereby first portion 9 and second portion 11 are hingedly joined proximate a bottom end 13, and selectively lockable together at a top end 15. First portion 9 and second portion 11 may be rotated with respect to one another in the directions of Arrow A to selectively move security container 3 between an open position (FIG. 1) and a closed position (not shown). First portion 9 is intended to be formed of generally transparent or translucent material to allow a user to see the contents of security container 3 when in the closed position.

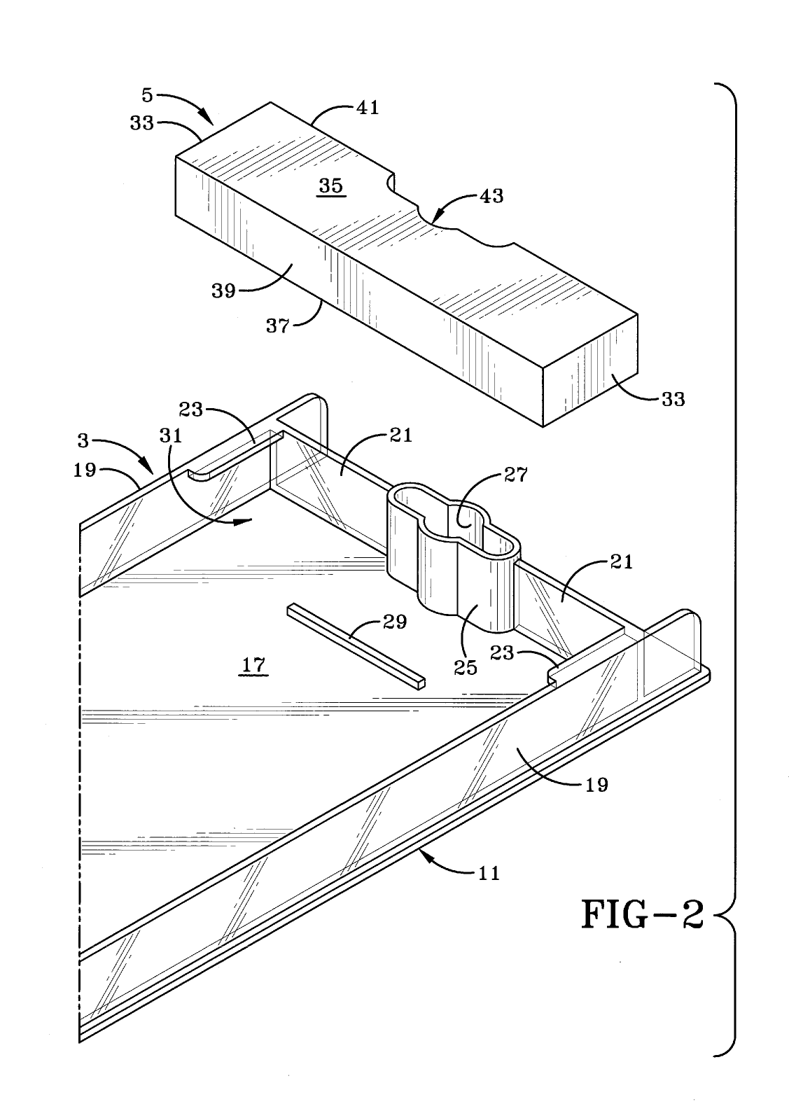

As shown in FIG. 2, security device 3 further includes a backwall 17, a pair of sidewalls 19, a pair of top walls 21, and a peg receiving wall 25 defining a peg opening 27. Security device 3 further includes a pair of retaining lips 23 extending outwardly away from each sidewall 19 and topwall 21, and a retaining bar 29 extending from backwall 17. Retaining lips 23 and retaining bar 29 cooperate with backwall 17, sidewalls 19, topwalls 21, and peg receiving wall 25 to define a pocket 31, wherein pocket 31 is sized to receive cassette 5 and hold cassette 5 securely therein.

As shown in FIGS. 1 and 2, cassette 5 is generally a rectangular block of plastic material having a pair of side surfaces 33, a front surface 35, a back surface 37, a bottom surface 39, and a top surface 41 having a profiled area 43 and a recess formed therein (not shown) to hold a security tag. When cassette 5 is disposed in pocket 31, top surface 41 abuts topwalls 21, with profiled area 43 sized to complementary abut peg receiving wall 25. Likewise, back surface 37 abuts backwall 17 and side surfaces 33 abut sidewalls 19. As shown in FIG. 1, retaining lips 23 hold cassette 5 in pocket 31 by the abutment formed between retaining lips 23 and front surface 35. Likewise, retaining bar 29 holds cassette 5 in pocket 31 by the abutment formed between retaining bar 29 and bottom surface 39. As such, it will be readily understood that the abutments formed between cassette 5 and security container 3 generally prevent any meaningful movement in all directions when cassette 5 is disposed in pocket 31. As such, cassette 5 is sized and shaped to be selectively disposed in pocket 31 and held therein when security container 3 is in the closed position.

Cassette 5 may be a solid block of material or may include a cavity or opening (not shown) to hold a security tag (not shown) therein. Cassette 5 is intended to have a particular color displayed at least on front surface 35. It is also envisioned that cassette 5 may be formed having this color displayed on all surfaces. As such, multiple cassettes 5 may be included in the present invention and each cassette 5 may be formed having a different color displayed on front surface 35.

In operation, a user opens security container 3 to expose pocket 31 in second portion 11. The user then places cassette 5 inside second portion 11, generally having back surface 37 proximate or abutting second portion 11, side surfaces 33 proximate or abutting sidewalls 19, and top surface 41 proximate and facing top end 15. The user then slides cassette 5 over retaining bar 29 such that retaining bar 29 abuts back surface 37 and retaining lips 23 abut front surface 35. When cassette 5 moves entirely over retaining bar 29, cassette 5 drops into pocket 31 whereby cassette 5 is held securely therein by the various surfaces and retaining elements as discussed above. Cassette 5 is selectively removable from security container 3 by reversing the above steps, and moving back surface 37 over retaining bar 29 to release cassette 5 from pocket 31.

When cassette 5 is securely held in pocket 31 and security container 3 is in the locked position, whatever color is displayed on front surface 35 is outwardly facing in security device 1 through transparent first portion 9, and is readily viewable by a user holding or looking at security device 1. When a user wishes to change the visible color displayed by cassette 5 in security container 3, the user simply removes cassette 5 and replaces it with another cassette 5 having the desired color displayed on front surface 35. As such, the color displayed by security container 1 proximate top end 15 is changeable and customizable by the user simply by changing cassettes 5.

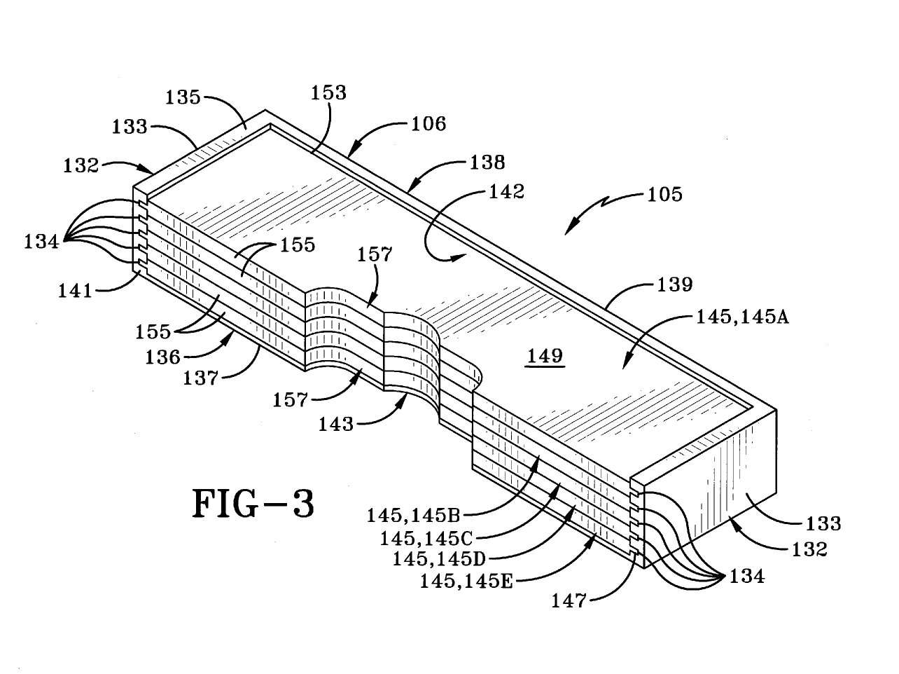

With particular reference to FIGS. 3-8, a second embodiment of the cassette is indicated generally at 105. Cassette 105 is intended to be used with security container 3 in the same general manner as described above with respect to cassette 5, as the overall size and shape of cassette 105 is substantially similar to cassette 5. As such, cassette 105 is inserted and removed from pocket 31 in the manner described above.

Cassette 105 includes a cassette base 106 and a plurality of slides 145. Cassette base 106 includes a pair of sidewalls 132, a backwall 136, and a bottom wall 138 which defines a plurality of tooth slots 140 therein. Sidewalls 132 define a plurality of elongated grooves 134 extending generally from bottom wall 138 along the entire length of sidewalls 132. Sidewalls 132 and bottom wall 138 define a window 142. Cassette base 106 further includes a pair of side surfaces 133, a front surface 135, a back surface 137, a bottom surface 139, and a top surface 141 having a profiled area 143. Sidewalls 132, backwall 136, and bottom wall 138 define an inner cavity 144 (FIG. 6) wherein the plurality of slides 145 may be selectively disposed, shown in FIG. 3 as five slides: 145A, 145B, 145C, 145D, and 145E.

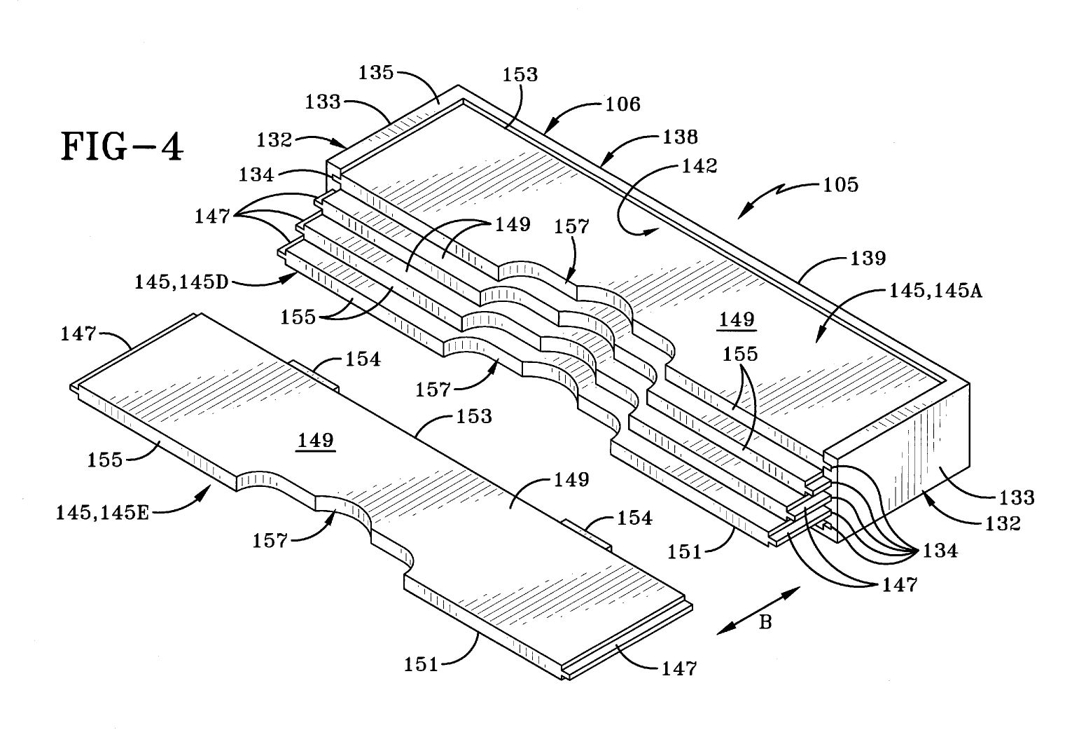

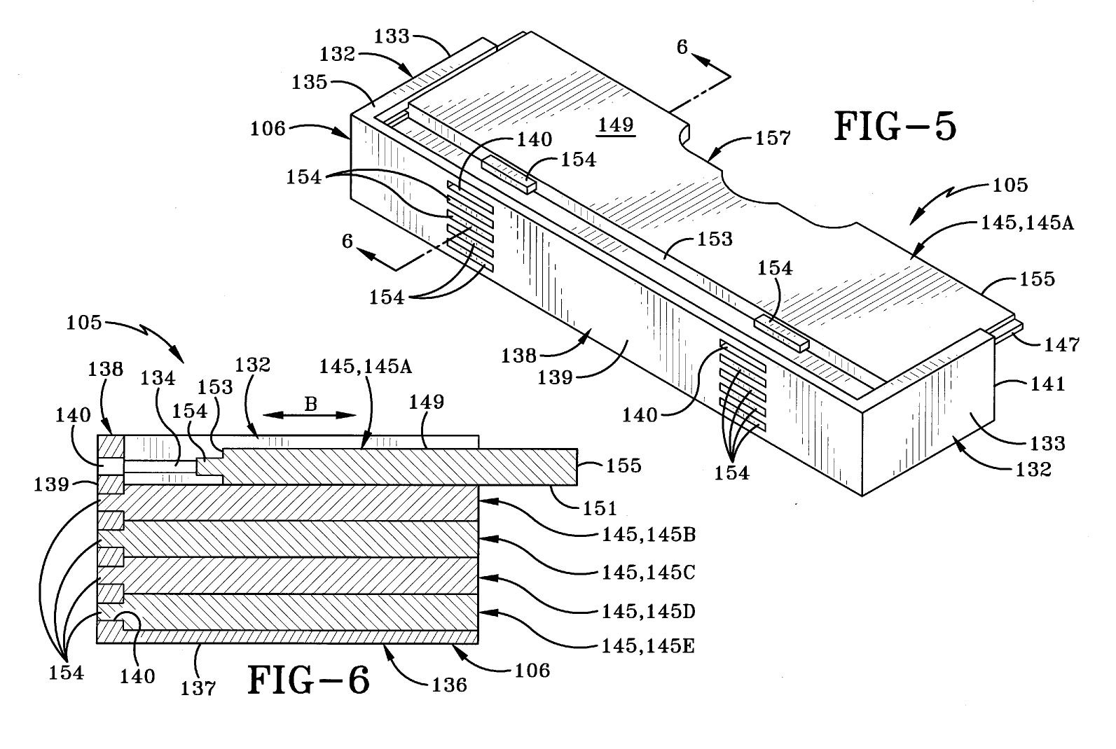

As shown in FIGS. 4-6, each slide 145 is a flat and elongated integral member terminating in a pair of slide projections 147 at each end. Slide 145 includes a front surface 149, a back surface 151 (FIG. 6), a bottom surface 153 (FIG. 5), and a top surface 155 having a profiled area 157. A pair of teeth 154 (FIG. 5) extend outwardly away from bottom surface 153, each of which are complementary shaped to fit into tooth slots 140. Projections 159 include a generally rectangular cross-sectional shape and extend entirely from bottom surface 153 to top surface 155 of slide 145.

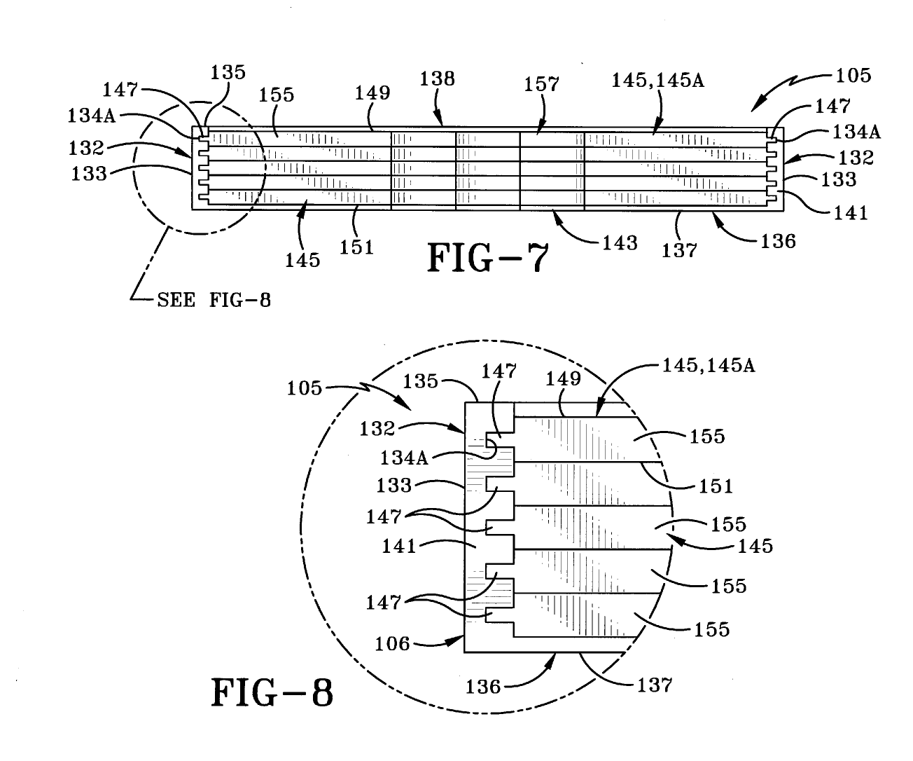

As shown in FIGS. 4 and 5, each slide 145 is independently movable within inner cavity 144 along the directions of Arrow B. Elongated grooves 134 are sized to receive projections 147 and guide slide 145 into a stable position within inner cavity 144 of cassette base 106. As shown in FIGS. 5 and 6, tooth slots 140 are aligned to receive teeth 154 extending from bottom surface 153 of slide 145 and properly align and secure slide 145 with bottom wall 138 of cassette base 106. As shown in FIGS. 6 and 7, it is intended that each slide 145 has a corresponding set of elongated grooves 134 in sidewalls 132, and a set of tooth slots 140 in bottom wall 138, such that all slides 145 may be disposed in cassette base 106 at the same time for safekeeping and to provide a “self-contained” multi-colored cassette to the user.

As discussed above, sidewalls 132 and bottom wall 138 form window 142 in cassette base 106. As shown in FIGS. 5-8, window 142 is most proximate a particular elongated groove 134A. When slide 145A is placed in elongated groove 134A, slide 145A is outwardly visible through window 142. It is intended that each slide 145 be formed having a particular color. For example, slide 145A is primarily white in color, slide 145B is primarily blue in color, etc. Inasmuch as slides 145 are formed having a particular color, the particular slide 145A which resides in elongated grooves 134A portrays that color outwardly from cassette base 106. When cassette 105 is placed into security container 3, the color of slide 145A disposed in elongated slots 134A is outwardly displayed therefrom. As such, it will be readily understood that a user may select and rearrange the plurality of slides 145 as desired to change the outwardly facing color of cassette 105, thereby changing the overall color displayed proximate top end 15 of security container 3.

It will be readily understood that a security tag (not shown) may be disposed anywhere in or on security device 1, including inside cassette 5 or cassette 105, first portion 9, or second portion 11. Furthermore, it will be readily understood that having described cassette 5 and 105 as portraying a color, any alternative to a solid color is encompassed by the present invention, including wording, indicia, visual characteristics, or multi-colored front surfaces 35 or 135.

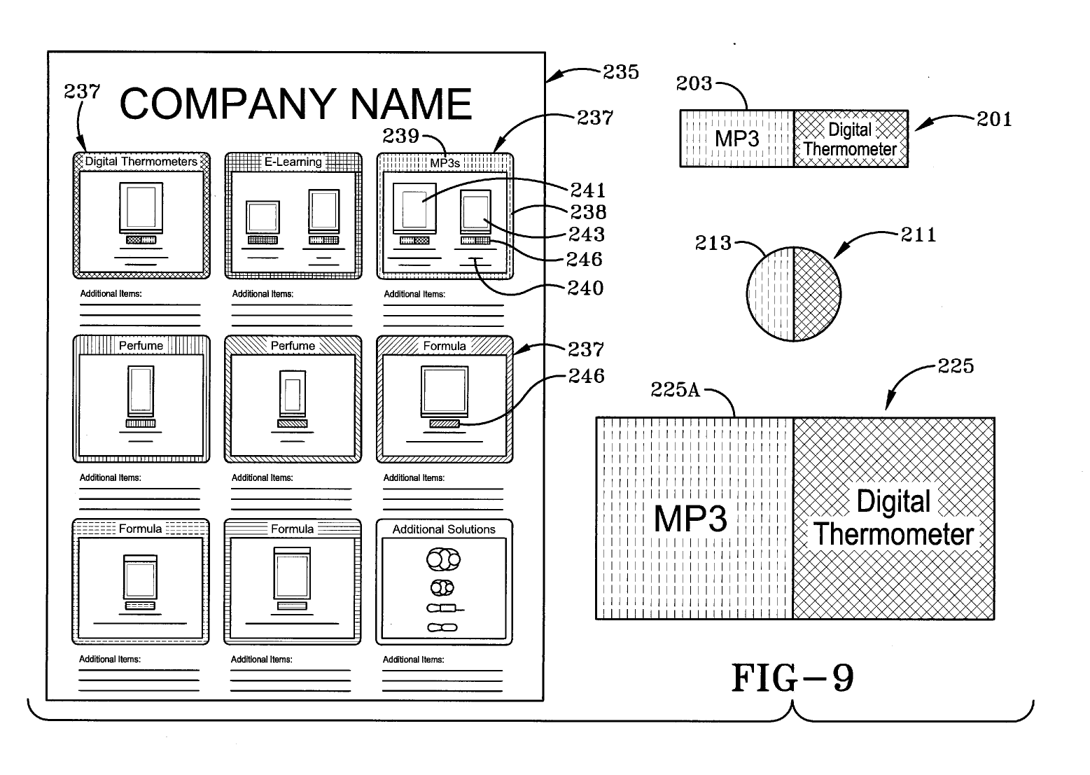

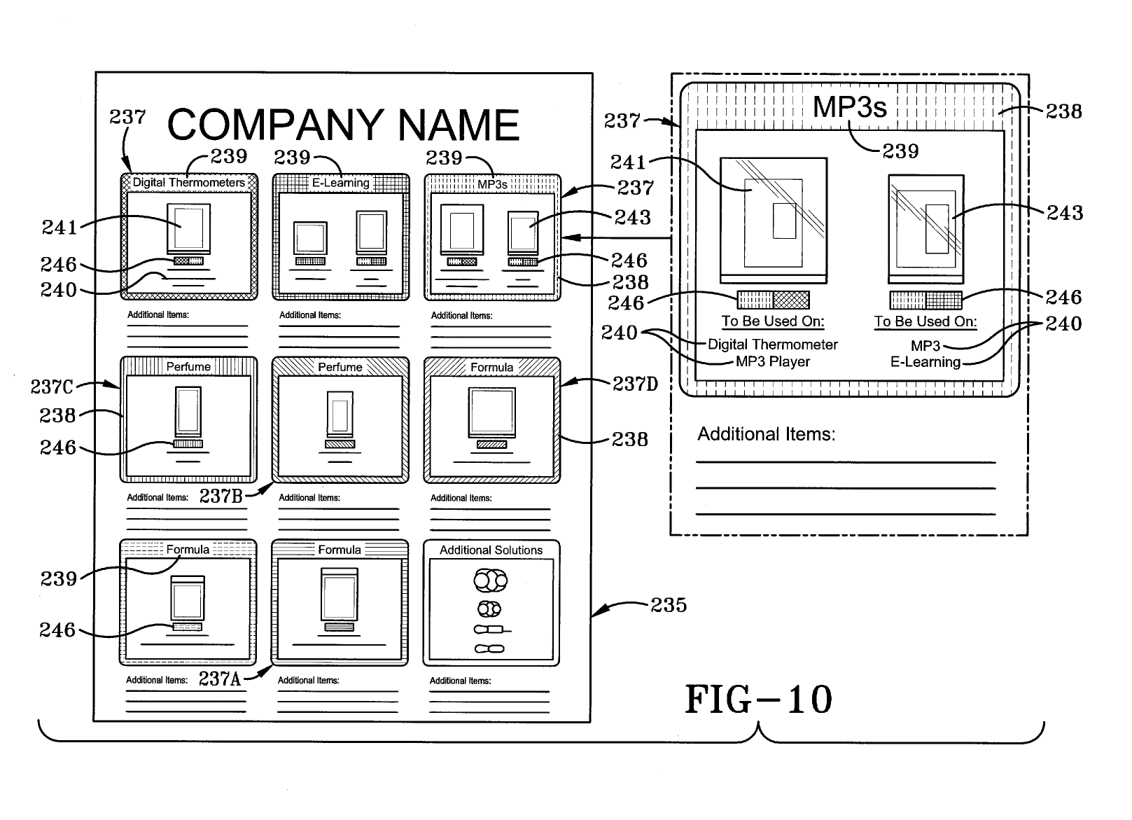

A modified form of the invention is shown particularly in FIGS. 9-13. This embodiment shows a modified system, method, and kit for the pairing of security devices with retail products and provides the retailer with an accelerated in-store organization and storage processes as well as increasing the efficiency of store associates and amplifies on-shelf availability. Furthermore, it reduces the amount of time for shelf stocking and accelerates organization of the back room and sales floor and ensures that the correct security device is recycled back into the appropriate merchandise category to better protect high theft merchandise.

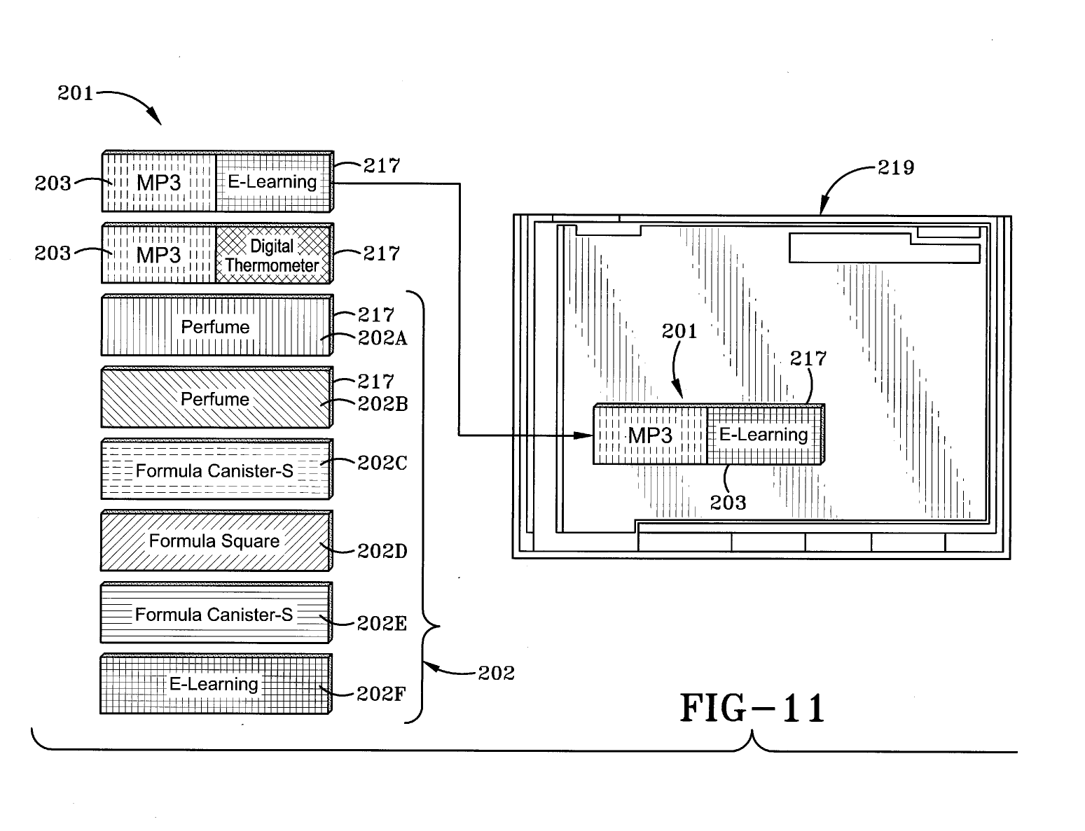

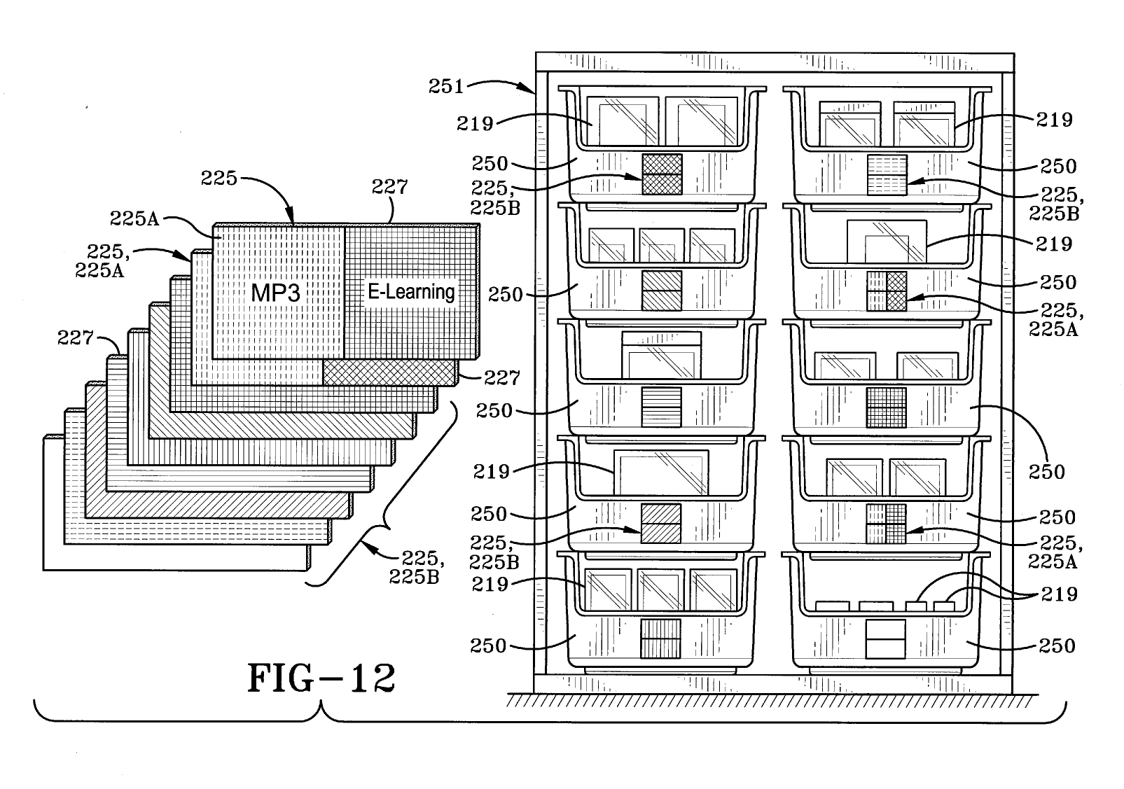

The main components of this modified embodiment are shown in FIG. 9 and includes a first plurality of identifying indicia for the various security devices indicated generally at 201, which in the preferred embodiment is a plurality of labels having color indicia thereon, several of which are shown in further detail in FIG. 11. The security device indicia labels 201 can have various geometric shapes such as rectangular (as shown in FIGS. 9 and 11), square, oblong, circular, etc. without affecting the concept of the invention. Furthermore, as shown in FIGS. 9 and 11, security device indicia labels 201 are provided with various colors and can all be of one color as indicated generally at 202, or be bi-colored as indicated at 203, the purpose of which is discussed further below. Furthermore, as illustrated in FIG. 11, the labels will be of various colors such as label 202A is red, label 202B is green, label 202C is gray, label 202D is tan, label 202E is blue, label 202F is yellow, etc.

Another main component of the merchandising system is a second plurality of identifying indicia best shown in FIGS. 9 and 13, which in the preferred embodiment consists of a plurality of color-encoded labels indicated generally at 211. Labels 211 can have various colors such as the seven single different colored labels 212 shown in FIG. 13, each being a different color, or a bi-colored label 213 shown in FIGS. 9 and 13. These labels, as well as the security device indicia labels 201, are preferably formed of a type of card stock, plastic or synthetic material and preferably have a laminate overcoat to prevent scratching, water damage, daily wear and tear and preferably will have a pressure sensitive adhesive 217 on a back surfaces thereof.

In accordance with the invention, each of the various security devices, examples of which are shown in FIGS. 11 and 13, and indicated generally at 219, have one of the indicia labels 201 applied thereto by the pressure sensitive adhesive 217. These security devices can be of various types, such as lock boxes (examples of which are shown in U.S. Pat. Nos. 6,125,668; 7,194,879; 7,262,699; 7,598,861 and 7,963,131); cable locks (examples of which are shown in U.S. Pat. Nos. 6,755,055 and 7,403,118); cable wraps (examples of which are shown in U.S. Pat. Nos. 5,722,266; 6,092,401 and 7,162,889); or other types of security devices.

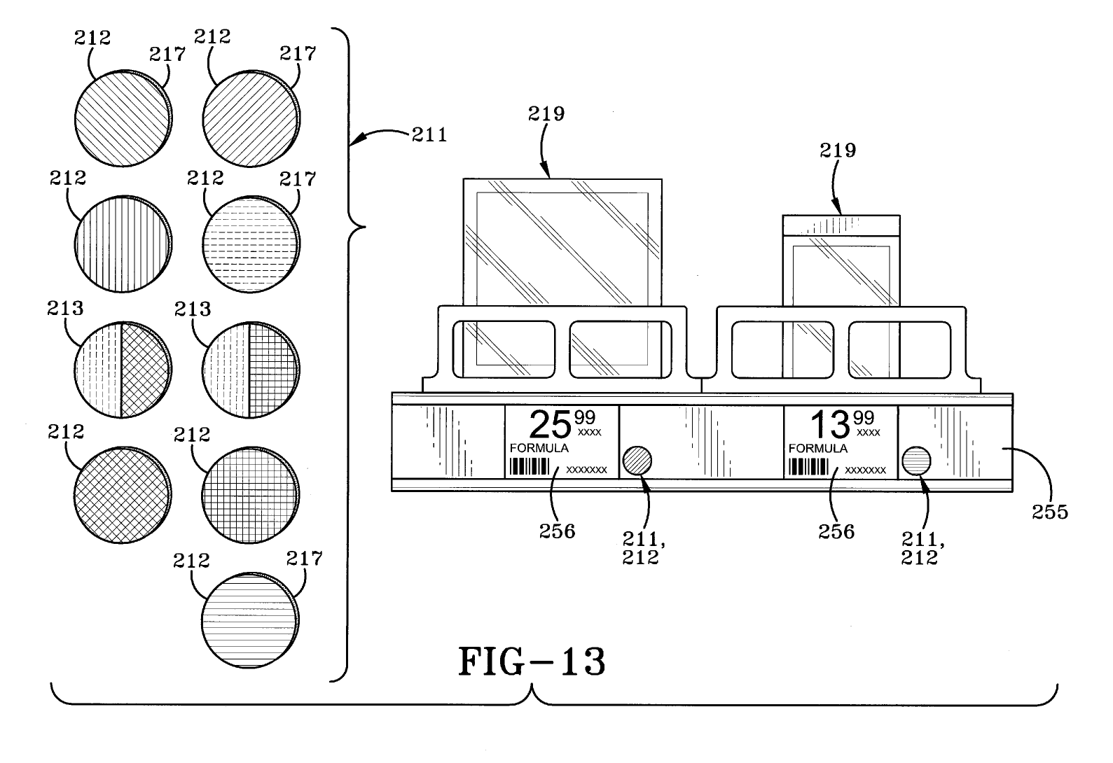

Still another component of the present invention is a plurality of third identifying indicia indicated generally at 225, shown particularly in FIGS. 9 and 12, referred to as bin labels. Labels 225 preferably are formed of paper, card stock, or other material, again protected with a laminate overcoat and having a pressure sensitive adhesive 227 on a back surface thereof. Labels 225 may have a dual color code thereto as shown by label 225A in FIGS. 9 and 12 or could be a single color as shown by labels 225B in FIG. 12.

Another component of the improved merchandising system is a poster indicated generally at 235 (FIGS. 9 and 10), having a plurality of color box pictorials each indicated at 237 printed thereon, an enlargement of one being shown in FIG. 10. Each color box pictorial 237 has a particular colored outline 238 and preferably will have printed thereon at 239, the name of the particular retail product to be color matched to the colored outline 238. Color box 237 preferably will have a pictorial representation as indicated at 241 and 243 of the particular retail products to be matched with the color outline of color box 237, and also has the product description 240 imprinted thereon. A label pictorial 246 may be printed below the product pictorials 241 and 243, which can be dual color as shown, single color, or tri-colored to represent the merchandise category protected by the particular security device. One of the colors of pictorial 246 will be that of the color outline 238. Color pictorial 246 may have a particular color code such as used for a digital thermometer, which is also suitable for protection by other security products having the color code matching that of color outline 238 of color box 237.

Poster 235 preferably contains a number of color boxes 237, nine of which are shown in FIG. 10, each of which will have a different color border such as blue 237A, green 237B, red 237C, tan 237D, etc., all of which relate to a particular security device as well as listing the various retail products to be protected by the particular color-coded security device.

The third identifying indicia labels 225 are bin labels intended for use on storage bins 250 (FIG. 12). A plurality of storage bins 250 preferably are mounted in a storage rack 251 and will have a particular color-coded bin label 225 on the front face of each individual bin. Labels 225 may be of a single color, dual, tri-colored etc. depending upon which security device is to be placed into the individual bins, and to what retail product will be theft protected by the particular security device. Racks 251 and bins 250 may be located adjacent the checkout counter, back room, or other convenient location in a store for easy access by store personnel.

Set forth below is a detailed description of the method of use of these components to achieve the desired results discussed above.

Each particular security device 219, whether it be a lock box, cable lock, cable wrap, etc. has a particular color-coded label 201 attached thereto as shown in FIG. 11, whether it be a dual color as shown in FIG. 11, or a single or tri-color label without affecting the invention. These labels will remain with the security device and the color code of the label will be matched with the color code on shelf labels 211, which color code will be associated with a particular product. For example, one of the labels 202F shown in FIG. 11 can be solid yellow and will be associated with eLearning products, or could be purple associated with MP3 players, red associated with a particular perfume, etc. Thus, an appropriate security device label 201 will be placed on the appropriate security device 219 which is intended for use with the particular retail product identified by the color indicia on the label, and in certain instances may have the generic name of the product or the brand name imprinted on the label.

A clerk will refer to poster 235 which will indicate immediately which of the retail products is intended to be protected by what security device by the color-coding of the color box pictorial 237 contained on poster 235. Poster 235 preferably will be located in a back room area where the products are stored prior to being placed in the retail area accessible by customers. Thus, a clerk will look at the color box of poster 235 for a particular product and by matching the color thereof with the color of the label on the security device will know to match the two together before placing the protected product into the customer accessible area. After a protected product has been purchased, a clerk at the checkout counter will remove the product from the security device. The security device ultimately will be returned to a back room area, where depending upon the color of the label on the security device will be easily placed in the correct storage bin 250 if not done at the checkout counter, by matching the security device label 201 with the color of the bin label 225. These returned security devices then can be easily retrieved for reuse by a clerk and matched with the appropriate product to be used therewith, again by viewing poster 235.

In accordance with another feature of the present invention, each retail product will have a particular label 211 assigned thereto, whether it be a single color or a multiple colored label which will be placed on a display shelf 255 as shown in FIG. 13, by itself or in combination with a price label 256. Labels 211 enable a clerk to easily know where to place a particular product for display after the product has been placed in its appropriately matched security device by matching the color of the product labels 211 with that of the color box 237 listed on poster 235 or the colored label 201 on the security device.

Thus, a clerk can quickly match a particular product with the required security device and then easily and quickly place the protected product on the correct shelf by matching the color-coding of the labels with the shelf labels 211 as shown in FIG. 13. Likewise, each of the used security devices are returned to an appropriate storage bin 250 by matching the security product label 201 with the bin label 225. Thus, the color of the various labels are easily recognized and matched with the corresponding color of the other labels whether it be used in returning the used security devices to their appropriate storage bins, or placing the correct product with the correct security device or returned to the proper retail department, and then the subsequent placement thereof on the correct shelf for ultimate purchase by a customer. Again, the various labels can be single color labels, dual color, tri-color, etc., each color being associated with a certain product indicating that a single security device is suitable for use with various products, again which is easily and quickly recognized by a clerk. Furthermore, the various color-coded labels are preferably made of a laminate protected material having the printed indicia and color-coding thereon, and can be cardstock in various sizes and configurations, and preferably having a pressure sensitive adhesive on the back surface thereof for attachment of the labels to the storage bin, display shelf, and various security devices. Likewise, depending upon the particular product, a color-coded label could be attached directly to the product enabling it to be visually and quickly matched with the appropriate security device intended for its protection.

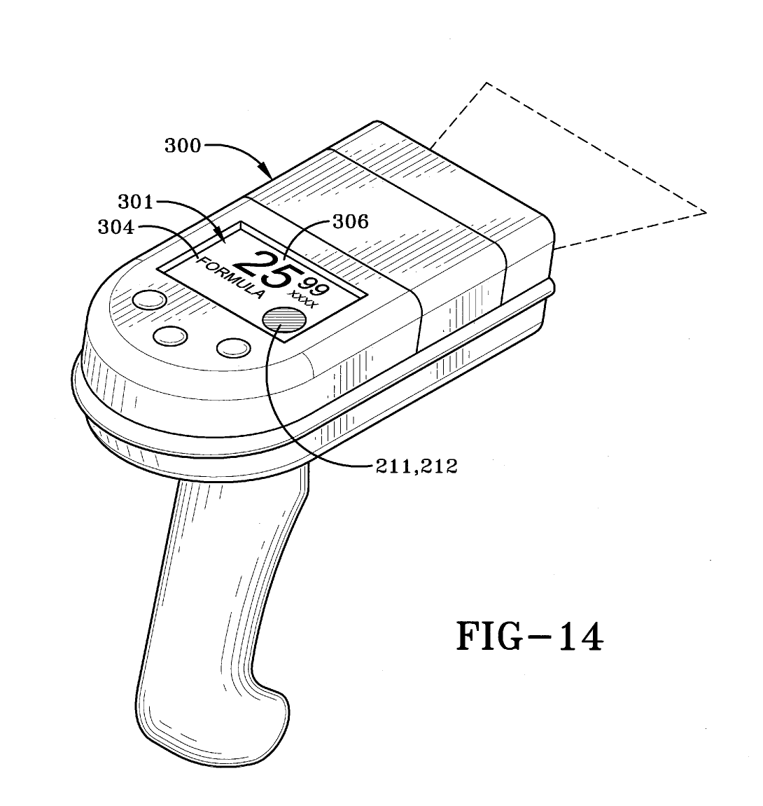

Another configuration of the preferred embodiment extends to the use of the color coded labels 211 as discussed above with reference to FIGS. 9 and 13 to using them with electronic devices such as the example product scanner shown in FIG. 14. FIG. 14 illustrates this embodiment in conjunction with the use of a wireless handheld product scanner 300. However, this embodiment may be implemented in any suitable devices including wired product scanners, inventory scanners, and the like.

The scanner 300 can be a wireless network device communicating over a wireless network with one or more databases. When a product is scanned by the scanner 300, the scanner 300 is adapted to request product information about that product from a database on a network. Alternatively, the scanner 300 can retrieve the product information from a memory device internal to the scanner or in other ways as understood by those of ordinary skill in the art. When a scan is made and product information is retrieved, the scanner 300 is configured to display at least some of the product information on a display 301. Example information that may be displayed includes a product type 304, product price 306 and a color-encoded label 211 discussed earlier that may be similar to the seven different colored labels 212 in FIG. 13 that were also previously discussed.

The use of the scanner with the color-encoded label 211 is now described in an example retail scenario. For example, a store clerk will receive a product that is to be displayed in a retail environment of a store. When the product is received or sometime later, the clerk will scan the product in a storage area of the store in preparation of displaying the product. As previously mentioned, when the product is scanned, the scanner will retrieve product information that includes a color-encoded label 211 that is displayed on the scanner display 211.

The clerk can easily look at the display and by the color or color patterns of the color-encoded label 211 know what type of security device 219 should be associated with that product. For example, a red colored label 211 may indicated that the product should be protected with one type of security device 219 and a green label 211 may indicated that the product should be protected with another type of security device 219. For example, a red label 211 may mean a lanyard type of security device should be looped through the product and securely locked into a housing of the cable lock. Alternatively, a green label can indicate that the product should be secured within a box type of security device with a locking lid.

In general, this embodiment allows a store clerk to determine at a time when they are scanning and preparing products for display what is the appropriate security device 219 to place on each kind of product. This may be more efficient than referring to the poster 235 discussed above that mapped products to security devices 219. Having a handheld device map products to security devices 219 relieves the clerk from needing to go to place where the poster 235 is located and relieves the clerk from having to decipher the poster 235 to determine what security device 219 is associated with a product.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A merchandising system comprising:
a plurality of various security devices;
a first plurality of identifying indicia, each of which is carried by one of the security devices;
a second plurality of identifying indicia, each of which is adapted to be closely associated with a particular retail product; and
wherein said first and second indicia each contain a feature enabling the first and second indicia to be visually matched to enable each of the retail products to be theft-protected by a correct one of the security devices.

2. The system defined in claim 1 wherein each of the first and second identifying indicia is a color.

3. The system defined in claim 1 wherein the first identifying indicia is a label attached to the security devices by an adhesive.

4. The system defined in claim 1 wherein the second identifying indicia is a label attached to a shelve on which a retail product associated with the identifying indicia is located.

5. The system defined in claim 1 including a plurality of storage bins, each of said bins having a third identifying indicia associated with each of said bins, wherein each of said third indicia contains a feature enabling the first indicia of the security device to be matched to third indicia enabling the security devices to be placed in the appropriate bin for subsequent receiving the correct one of the retail products.

6. The system defined in claim 5 wherein the first and third identifying indicia are matched colors.

7. The system defined in claim 4 wherein the first identifying indicia includes two different colors visually indicating that two of the retail products can be theft-protected by the certain one of the security devices on which a corresponding color label is attached.

8. The system of claim 1 further comprising:
a scanning device with an electronic display adapted for scanning the particular retail product and displaying on the electronic display one of the second plurality of identifying indicia associated with the particular retail product.

9. A kit for merchandising and protecting from theft certain retail products comprising:
a variety of security devices;
a first plurality of identifying indicia, each of which is adapted to be carried by one of the security devices;
a second plurality of identifying indicia, each of which is adapted to be associated with a particular retail product; and
wherein said first and second indicia each contain a feature enabling the first and second indicia to be visually matched to enable each of the retail products to be theft-protected by a certain one of the security devices.

10. The kit defined in claim 9 wherein each of the first and second identifying indicia is a color.

11. The kit defined in claim 9 wherein first and second identifying indicia are color labels.

12. The kit defined in claim 9 including a plurality of storage bins, each of said bins having a third identifying indicia associated with each of said bins, wherein each of said third indicia contains a feature enabling the first indicia of the security device to be matched to third indicia enabling the security devices to be placed in the appropriate bin for subsequent receiving one of the retail products.

13. The kit defined in claim 12 wherein the first and third identifying indicia are matched colors; and wherein the matched colors of the first and third identifying indicia are placed on labels attached to the security devices and storage bins respectively by an adhesive.

14. The kit defined in claim 9 wherein the first and second identifying indicia each includes two different colors visually indicating that two different retail products can be theft-protected by a certain one of the security devices.

15. The kit defined in claim 9 including a poster containing a color pictorial of color-coding of the retail products and security devices for subsequent visual matching.

16. A method of merchandising a variety of retail products comprising the steps of:
providing a plurality of various security devices;
providing a first plurality of identifying indicia, each of which is carried by a particular one of the security devices;
providing a second plurality of identifying indicia, each of which is closely associated with a particular retail product, wherein said first and second indicia each contain a feature enabling the first and second indicia to be visually matched to each other; and
coupling at least one of the various security devices with an appropriate one of the retail products of the type intended to be protected by an associated security device, wherein the coupling is performed by visually matching the features of the first and second indicia.

17. The method defined in claim 16 including the step of providing the first and second indicia with color-coding.

18. The method defined in claim 16 including the step of providing a plurality of storage bins, each of said bins having a third identifying indicia associated with each of said bins, wherein each of said third indicia contains a feature enabling the first indicia of the security devices to be matched to the third indicia enabling the security devices to be placed in an appropriate bin for subsequent matching with a correct one of the retail products.

19. The method defined in claim 18 including the step of attaching the first and third indicia on the security devices and bins respectively, by an adhesive.

20. The method defined in claim 16 including the step of providing a poster containing a color pictorial of color-coding of the retail products and security devices for subsequent visual matching.

21. The method defined in claim 16 further comprising:
with a scanning device associated with a display, scanning identifying information on a first retail product;
displaying a first identifying indicia associated with the first retail product on the display;
matching the displayed first identifying indicia to at least one of the group of: a first security device and a first product display location; and
performing at least one of the group of: securing the first security device to the first retail product and placing the first retail product on display at the first product display location.

22. The method of claim 21 further comprising:
with the scanning device, scanning identifying information on a second retail product;
displaying a second identifying indicia associated with the second retail product on the display;
matching the displayed second identifying indicia to at least one of the group of: a second security device and a second product display location;
wherein the first security device is different that the second security device and the and first product display location is different than the second product display location; and
performing at least one of the group of: securing the second security device to the second retail product and placing the second retail product on display at the second product display location.
